(19) United States
(12) Patent Application Publication
(10) Pub. No.: US 2019/0337186 A1
(43) Pub. Date: Nov. 7, 2019

(54) TEXTILE REINFORCED CONCRETE SYSTEMS AND METHODS

(71) Applicants: Barzin Mobasher, Paradise Valley, AZ (US); Vikram Dey, Scottsdale, AZ (US); Jacob Bauchmoyer, Phoenix, AZ (US)

(72) Inventors: Barzin Mobasher, Paradise Valley, AZ (US); Vikram Dey, Scottsdale, AZ (US); Jacob Bauchmoyer, Phoenix, AZ (US)

(21) Appl. No.: 16/404,402

(22) Filed: May 6, 2019

Related U.S. Application Data
(60) Provisional application No. 62/668,010, filed on May 7, 2018.

(51) Int. Cl. B28B 1/52; B28B 3/02; B28B 11/24; B28B 23/02

(52) U.S. Cl. CPC B28B 1/52; B28B 23/02; B28B 11/245; B28B 3/02

(57) ABSTRACT

A pultrusion system, in accordance with various embodiments, is disclosed herein. The pultrusion system comprises a pulling mechanism and a slurry infusion bath. The pulling mechanism is configured to grasp and pull a textile through the infusion bath. The pultrusion system may comprise a feeding station to supply the textile to the pultrusion system. The pultrusion system may comprise a water bath configured to improve impregnation of a cement matrix from the slurry infusion bath.

### CROSS-REFERENCE TO RELATED APPLICATIONS

This application is a non-provisional of, and claims priority to, U.S. Provisional Application No. 62/668,010, filed May 7, 2018 and entitled “TEXTILE REINFORCED CONCRETE SYSTEMS AND METHODS” and which is hereby incorporated by reference in its entirety.

### FEDERALLY SPONSORED RESEARCH OR DEVELOPMENT

This invention was made with government support under contract No. 9211063 awarded by the National Science Foundation. The government has certain rights in the invention.

### TECHNICAL FIELD

The present disclosure relates to concrete, and in particular to textile reinforced concrete (TRC) products and methods for manufacturing and characterizing such TRC products. Alternative names for these concepts include textile reinforced mortar (TRM), fabric reinforced concrete (FRC), and fabric reinforced cementitious matrix (FRCM).

### BACKGROUND

The prospect of TRC as a legitimate alternative to common construction materials shows promise of many advantages including cost reduction, sustainability, structural longevity, durability improvement, impact, fatigue loading, as well as corrosion mitigation and repair and retrofit applications. Accordingly, improved TRC products, system, and methods are desirable.

### SUMMARY

A pultrusion system for manufacturing three-dimensional textile reinforced concrete products is disclosed herein. The system may comprise a feeding station, a slurry infusion bath, a calendar machine, and a pneumatic clamp. The feeding station may have a textile wound thereon. The slurry infusion bath may have rollers disposed therein. The calendar machine may comprise a first roller and a second roller, the first roller being disposed opposite the second roller, and the first roller being configured to rotate in an opposite direction of the second roller. The pneumatic clamp may be configured to grab, pull, and release the textile to convey the textile through the pultrusion system.

In various embodiments, the pneumatic clamp may be computer controlled. The system may further comprise a pneumatic press to shape the textile reinforced concrete. The system may further comprise a wet chamber for curing the textile reinforced concrete. The pneumatic clamp may comprise a lateral actuator and a vertical actuator, the vertical actuator being configured to grab and release the textile, and the lateral actuator being configured to pull the textile. The pneumatic clamp may further comprise a sliding table and a plate, the sliding table coupled to the lateral actuator, the plate being coupled to the vertical actuator, wherein the sliding table and the plate may be configured to receive the textile therebetween. The slurry infusion bath may comprise a cement based matrix. The slurry infusion bath may further comprise a chemical admixture.

A method for forming a three-dimensional textile reinforced concrete product is disclosed herein. The method may comprise: grasping, via a pneumatic clamp, a portion of a textile; pulling, via the pneumatic clamp, the textile to cause the textile to unroll from a feeding station, pass through a water bath, pass through a slurry infusion bath, and form an impregnated textile; and passing the impregnated textile through a calendar machine comprising rollers.

In various embodiments, the method may further comprise shaping the impregnated textile via a pneumatic press. The method may further comprise curing the impregnated textile in a wet chamber to form the three-dimensional textile reinforced concrete product. The grasping of the portion of the textile may further comprise clamping, via the pneumatic clamp, the textile between a plate and a sliding table. The pulling the textile further may comprise sliding the sliding table, via a lateral actuator of the pneumatic clamp. The impregnated textile may comprise a cement based matrix from the slurry infusion bath. The passing of the impregnated textile may further comprise squeezing the impregnated textile and uniformly distributing at least a portion of the cement based matrix across the textile.

### BRIEF DESCRIPTION OF THE DRAWINGS

With reference to the following description and accompanying drawings:

FIG. 1 illustrates a schematic view of an automated pultrusion system for TRC in accordance with an exemplary embodiment;

FIG. 2 illustrates a schematic view of a pneumatic clamp mechanism for use in an automated pultrusion system for TRC in accordance with an exemplary embodiment;

FIG. 3 illustrates a schematic view of a pneumatic clamp mechanism for use in an automated pultrusion system for TRC in accordance with an exemplary embodiment;

FIGS. 4A, 4B, and 4C illustrate exemplary textiles for utilization in TRC in accordance with an exemplary embodiment;

FIG. 5 illustrates characteristics of exemplary TRC products in accordance with various exemplary embodiments;

FIG. 6 illustrates L and C structural sections of exemplary TRC products in accordance with various exemplary embodiments;

FIGS. 7A, 7B, and 7C illustrate exemplary test configurations for TRC products in accordance with an exemplary embodiment;

FIGS. 8A and 8B illustrate characteristics of exemplary TRC products in accordance with various exemplary embodiments; and

FIG. 9 illustrates a method for forming a three-dimensional textile reinforced concrete product, in accordance with an example embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

For the sake of brevity, conventional techniques for building materials, construction, and use, as well as conventional approaches for mixture proportioning, ingredients, concrete forming, curing, reinforcing, and/or the like may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical textile reinforced concrete system, related methods, and/or products arising therefrom.

Principles of the present disclosure contemplate the development of new construction products as structural and non-structural components from TRC laminates such as angles, channels, hat sections, I sections, H sections, W sections, closed sections and sandwich sections with optimized cross sections fur general purpose construction materials. By developing methods to utilize, design, and construct cement based composites for structural applications, exemplary embodiments disclose sustainable new materials and design approaches. Disclosed herein are manufacturing equipment computer control algorithms, and electronic and manual manufacturing set up, for an automated production method to deliver a robust design methodology for continuous production of new composite sections that integrates materials ductility with serviceability, strength and long term durability. Exemplary structurally efficient and durable sections promise to compete with wood and light gage steel based sections for lightweight construction and panel application.

Moreover, principles of the present disclosure contemplate the creation of three-dimensional structural shapes, for example from textile reinforced concrete, for use in construction to replace wood and plastic products, such as pipes, closed cell, C channel, equal leg angle, T-section, hat section, box sections, and/or the like. Moreover, such principles contemplate application of these materials and techniques, for example to also include flat sections specifically used to create more complex shapes, such as trusses, and structural sections requiring connection of numerous pieces. Yet further, exemplary principles contemplate methods to fasten, and design of elements to connect, multiple pieces of these materials together to create complex structures. Additionally, exemplary principles contemplate modeling shapes and methods of fastening to ensure viability and safety in structural applications requiring substantial mechanical strength in various loading situations, such as bridges, trusses, foundations, underground components, etc.

Exemplary textiles suitable for use in connection with these principles may include polymeric materials, vegetable materials, E glass or alkali resistant glass, and basalt fibers; in certain applications, metallic fibers may be utilized. Exemplary matrix materials include cement, geopolymer materials containing alkali elements, fly ash or slag.

In particular, principles of the present disclosure contemplate utilization of computer controlled, automated, continuous manufacturing and shaping of the products for the intended purpose for a variety of applications.

An exemplary automated manufacturing system based on a pultrusion process is disclosed to fabricate full-scale structural sections with different thickness, shapes, effective lengths, and multiple layers of matrix and fabric elements. in this process an exemplary textile, for example Alkali Resistant Glass (ARG) textile, is impregnated with matrix and then stacked on a mold in between alternate layers of cement matrix. The equipment for pultrusion process may utilize a pneumatically controlled, automated pull-press-release mechanism (hereinafter referred to as a pneumatic clamp mechanism) based on tractor feed system. Transformation into an automated continuous process enables casting of long full-scale sections, and multiple pneumatic pressure points allow improvement in the impregnation process. The pultrusion technique allows for normal and shear stresses to be applied on the specimen to efficiently impregnate the textile, resulting in reduced porosity in the matrix, and better bonding at the interface. The design and manufacturing of a continuous tractor feed system as well as the shaping dies are important steps in the development of textile-cement laminates in order to move towards a continuous line of production. Such developments may be utilized in an industrial production phase using continuous manufacturing lines.

While cement production contributes to global warming, development of high performance, construction products with optimized cross sections inherently increases the efficiency of use of concrete materials in terms of specific strength (strength per unit weight of raw materials utilized). Principles of the present disclosure contemplate cement based materials that are 10 times stronger under tension, and 1000 times more ductile, stretchable, and energy absorbent. The developed methods are applicable to a wide range of new efficient and environmentally friendly construction systems. Tools have been developed to address material manufacturing and design, as well as non-linear mechanics used for design of structural systems. Exemplary composites can be developed with blended cements and geopolymers as well as carbon, glass, and polymeric textiles for truly efficient and sustainable composite systems. The design and product concepts can be instrumental for the design community in working with the next generation of sustainable materials.

Textile Reinforced Concrete (TRC) materials have many potential applications in the construction market. Exemplary embodiments disclose equipment and tools for their continuous and automated manufacturing in addition to sectional analysis of various shapes and forms for enhanced mechanical properties. The fundamental concepts of this idea disclosure include the manufacturing of new ductile TRC systems which exhibit significant ductility through material nonlinearity and integration of these non-linear mechanical properties into the design procedures for strain softening and strain hardening materials. Effect of fiber reinforcement in increasing the stiffness and ductility is established through the analytical work and proven through full scale strain field and shows that through controlled and distributed microcracking in brittle matrix composites, exemplary embodiments enable energy absorbing, compliant and durable materials. Disclosed herein are a variety of methods for the design and manufacturing with these class of materials using closed-form parametric, and nonlinear material models. A variety of base materials for formulation of matrix, fabric, and interface parameters are shown to work extremely well and adapt to this manufacturing method.

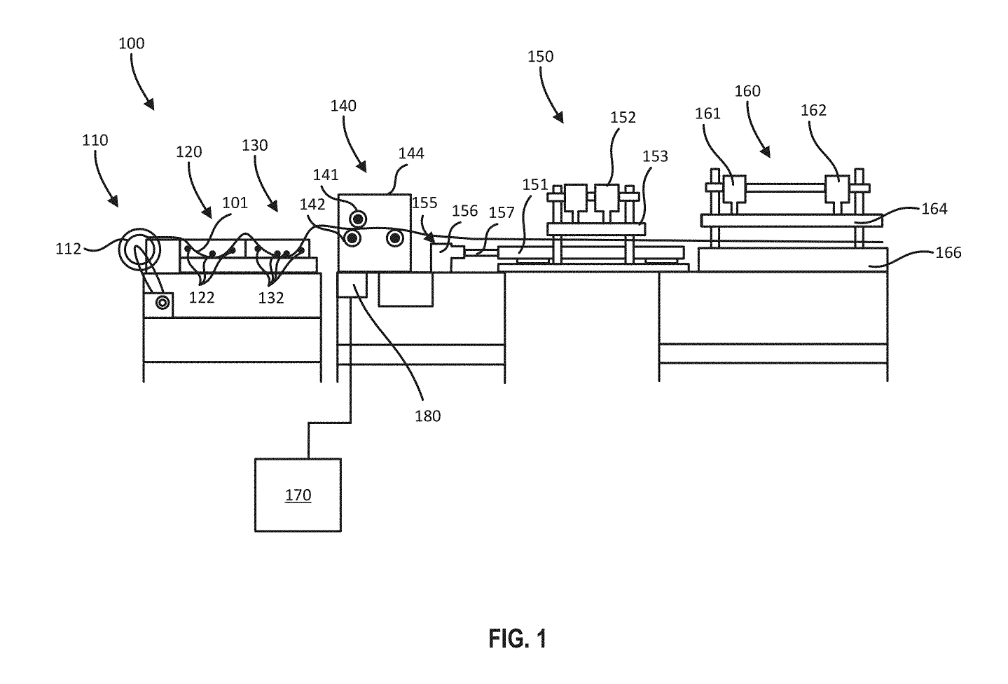

With reference now to FIG. 1, a schematic view of a pultrusion system for TRC, in accordance with an exemplary embodiment, is depicted. In an example embodiment, a pultrusion system 100 comprises a feeding station 110, a water bath 120, a slurry infusion bath 130, and a calendar machine 140. The feeding station 110 may comprise one or more spool(s) 112 each having a textile 101 wrapped around the spool. In an exemplary embodiment, the textile 101 is unwound from feeding station 110. The textile 101 may be unwound manually or automatically.

First, the textile 101 travels through the water bath 120. The water bath 120 helps improve impregnation of the textile fibers into the matrix. The water bath 120 may comprise chemical compound additives to further enhance the fabric-matrix bonding. The water bath 120 may comprise at least three rollers 122. The at least three rollers 122. may be oriented in a triangular pattern to enable uniform distribution of water on the textile 101 and/or maintain tension in the textile 101 as it moves down the line of the pultrusion system 100. The textile 101 is then coated in matrix paste at the slurry infusion bath 130.

In an example embodiment, the slurry infusion bath 130 comprises a series of frictionless rollers 132. The series of frictionless rollers 132 may be in a trapezoidal shape to enable additional contact points for the textile 101 submerged inside the slurry infusion bath 130. In an example embodiment, the slurry infusion bath 130 comprises a cement-based matrix. The slurry infusion bath 130 may further comprise chemical admixtures, such as high-range water reducers and/or hydration retarders. In an example embodiment, the slurry infusion bath 130 comprises mechanical needle vibrators.

The textile is then pulled through the calendar machine 140 via a first roller 141 and a second roller 142. The second roller 142 may be opposite the first roller 141 with the textile 101 between the first roller 141 and the second roller 142. In an example embodiment, the first roller 141 and the second roller 142 are coupled to at least one Direct Current (DC) motor through a universal joint and a mechanical coupler. The first roller 141 and the second roller 142 may be mounted on housing 144. The housing 144 may be a frame, such as a steel frame, or any other frame commonly known in the art. The motors are positioned opposite each other so that the first roller 141 and the second roller 142 spin in opposite directions and pull the textile 101 through the pultrusion system 100. The first roller 141 and second roller 142 squeeze the textile 101 as it passes through the calendar machine 140. By squeezing the textile 101, the first roller 141 and second roller 142 may uniformly distribute the cement-based matrix across the textile 101. Additionally, a majority of cells of the textile 101 may get filled with the matrix and the textile may remain in plane within the composite. It will be appreciated that in certain embodiments, other approaches for addition of paste may be utilized, for example spraying, or direct embedding of textiles in a closed container of paste.

In an example embodiment, the pultrusion system 100 further comprises a pneumatic clamp mechanism 150. The pneumatic clamp mechanism 150 comprises an actuator 155, a sliding table 151, and a pneumatic piston 152. The pneumatic pistons may have a compression pad 153 opposite the sliding table 151. The actuator 155 comprises a barrel 156 and a piston 157. The piston 157 is coupled to sliding table 151. The compression pad 153 may grip the textile 101 coated with the cement matrix (hereinafter referred to as impregnated textile) and pull it down the line on sliding table 151 as piston 157 actuates and then release the impregnated textile. The pneumatic clamp mechanism 150 acts as a pulling mechanism that drives the textile 101 through the production line as it grips and tows the textile 101 through each station. Impregnation of cement-based matrix into the open cell structure of the textile 101 is addressed through the rheology and static pressure applied during the operation of the pneumatic clamp mechanism 150. Then the compression pads are moved back to their starting position and the process is repeated.

In an example embodiment, the pultrusion system 100 further comprises a computer 170 and a controller 180. The computer 170 may be coupled to the controller 180. The controller 180 is coupled to the pneumatic clamp mechanism 150. The controller may be in communication with the pneumatic clamp mechanism 150 and control the feed rate of the textile 101. The controller 180 may comprise a processor and a tangible, non-transitory memory. The controller 180 may be configured to receive signals from the computer, such as a start signal, a stop signal, a feed rate signal, etc.

In an example embodiment, the pultrusion system further comprises a pneumatic press 160. The pneumatic press 160 can be on the production line, or it can be separate to the production line. The pneumatic press 160 comprises at least one pneumatic actuator 161 and a plate 164. In an example embodiment, the pneumatic press 160 may comprise a first pneumatic actuator 161 and a second pneumatic actuator 162. The plate 164 is coupled to the first pneumatic actuator 161 and the second pneumatic actuator 162. The plate 164 may be made of aluminum, steel, nickel, plastic, or any other material commonly known in the art. The plate 164 may preferably be made of aluminum. The plate may be heat treated in various embodiments. The pneumatic actuators (161, 162) may actuate vertically and press the plate 164 against the table 166, applying pressure to the impregnated textile. The pneumatic press 160 may apply pressure between 5 and 40 psi, more preferably between 10 and 20 psi. The pneumatic press 160 may improve the impregnation of the cement matrix inside the openings of the textile 101.

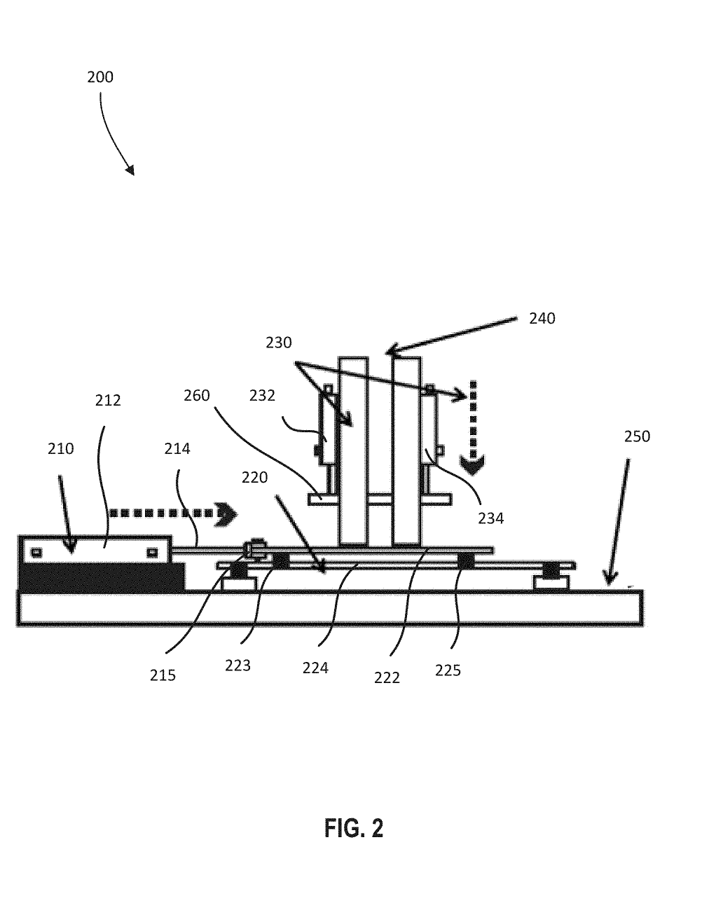

With reference now to FIG. 2, a pneumatic clamp mechanism 200 in accordance with an exemplary embodiment, is depicted. The pneumatic clamp mechanism 200 comprises a lateral actuator 210, a sliding table 220, a vertical actuator 230, a frame 240, and a tabletop 250. The lateral actuator 210 may comprise a housing 212 and a lateral piston 214. The sliding table 220 may comprise a moveable table 222 and a track 224. Moveable table 222 may be coupled to track 224 via a first fitting 223 and a second fitting 225. First fitting 223 and second fitting 225 may slidingly engage track 224. The lateral piston 214 may comprise an arm 215. Arm 215 may be coupled to moveable table 222 by any method known in the art. in an example embodiment, arm 215 is fastened to moveable table 222 via a fastener, such as a mechanically driven screw, a bolt and nut, or the like. In an example embodiment, vertical actuator 230 comprises a first vertical piston 232 and a second vertical piston 234. The vertical actuator may be coupled to frame 240. In an example embodiment, the pneumatic clamp mechanism 200 further comprises a compression pad 260. Compression pad 260 may be coupled to the first vertical piston 232 and the second vertical piston 234 and may be disposed opposite the moveable table 222. The vertical actuator 230 may be configured to actuate in the vertical direction towards moveable table 222 and apply a force.

In an example embodiment, a lamina may be disposed between the moveable table 222 and the compression pad 260. The vertical actuator 230 may apply pressure on the limina via the compression pad 260. The lateral actuator 210 drives the impregnated textile laterally as a pressure is applied vertically to the impregnated textile.

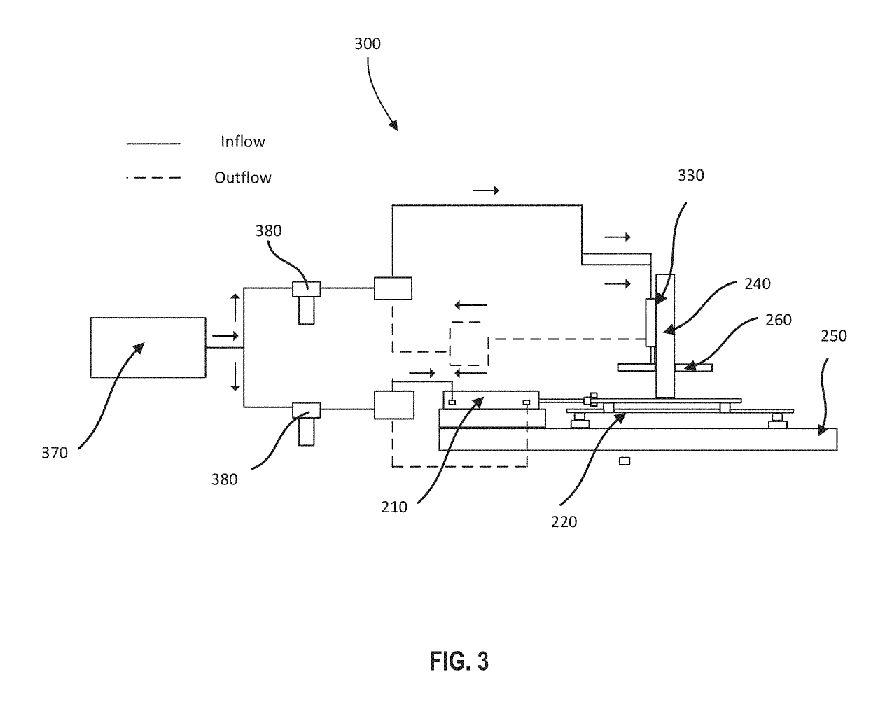

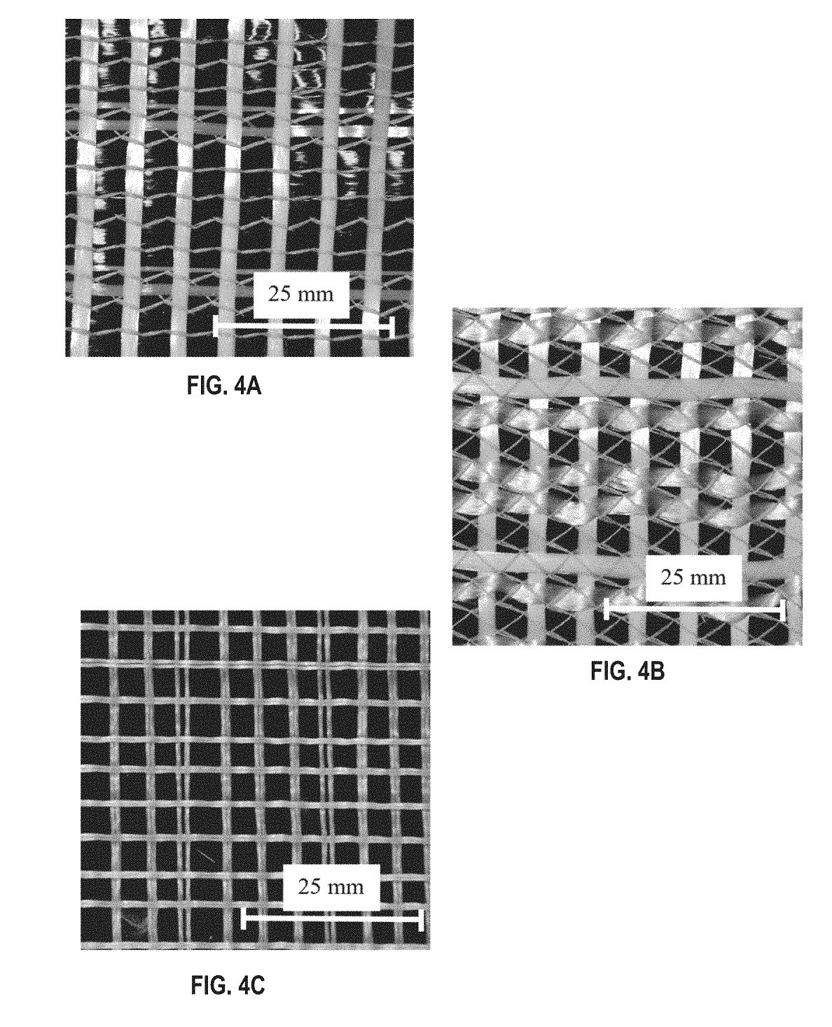

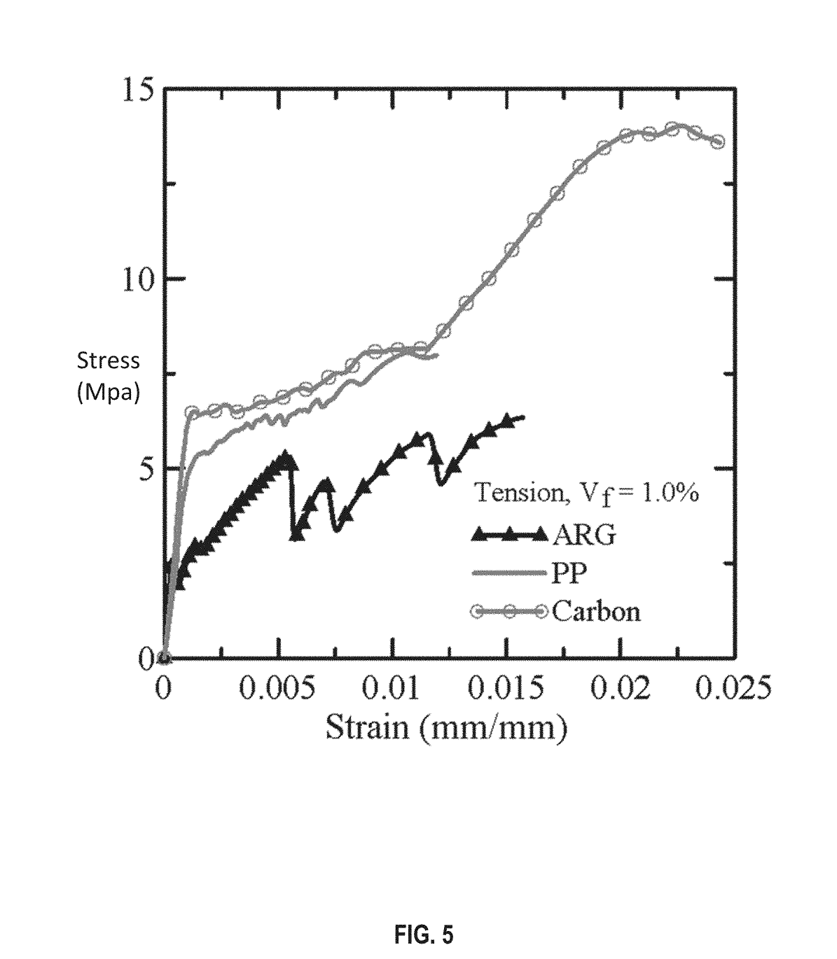

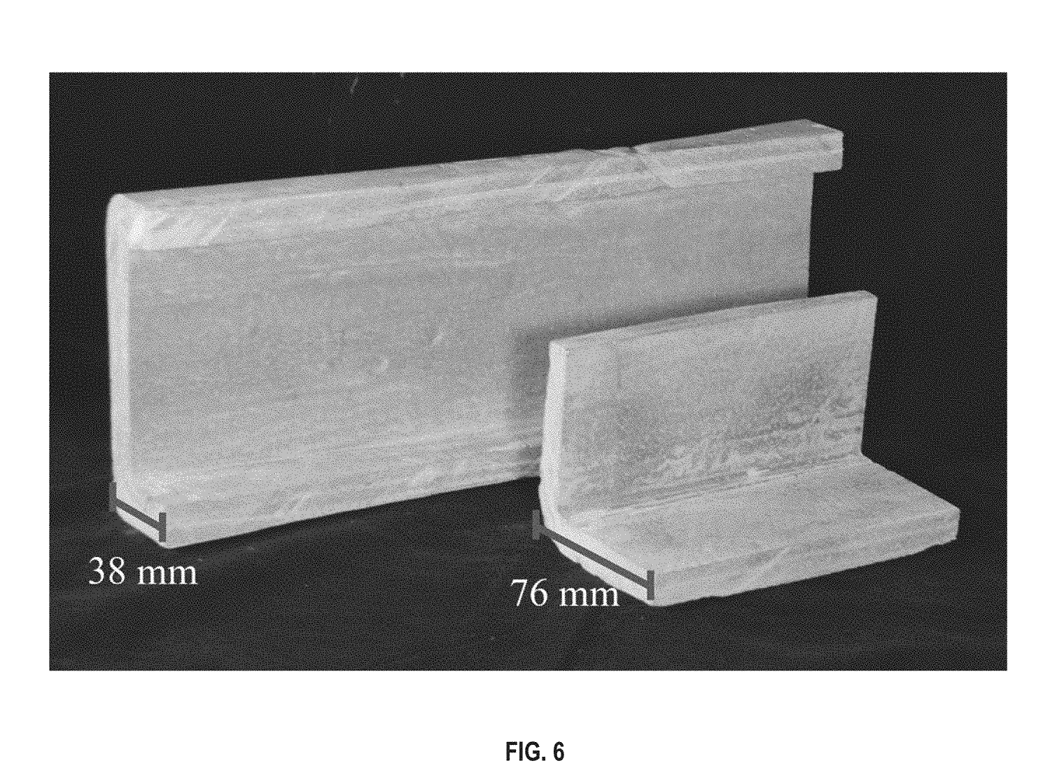

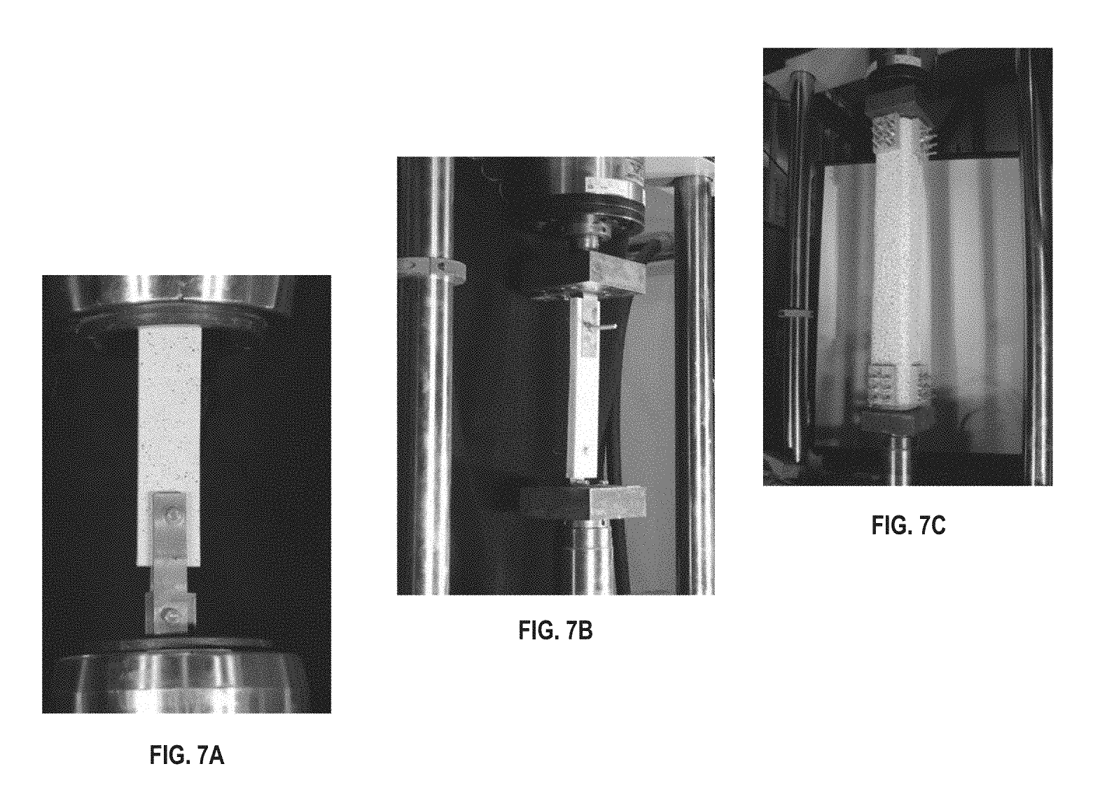

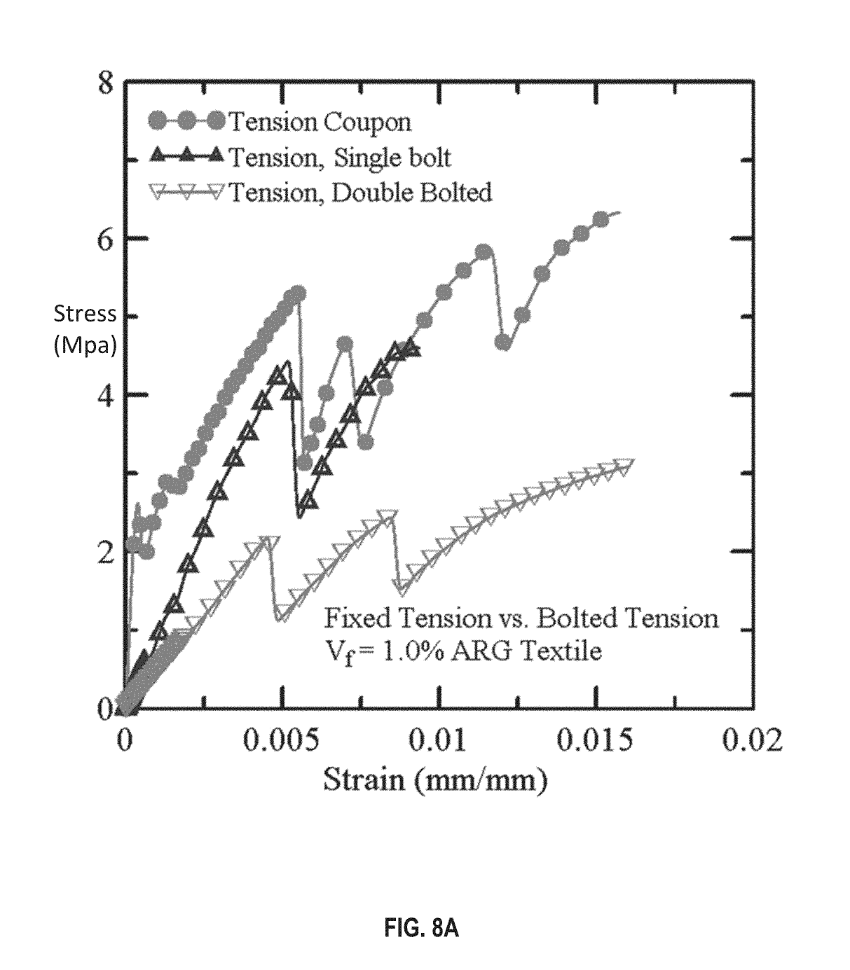

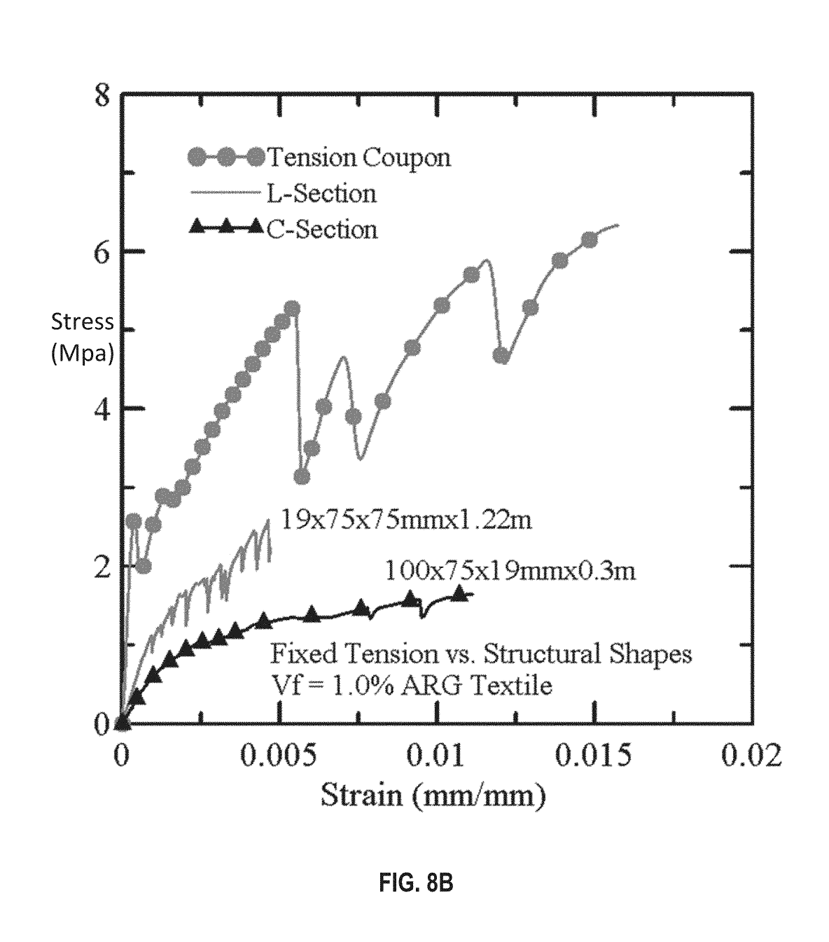

With reference now to FIG. 3, a pneumatic clamp mechanism 300 in accordance with an exemplary embodiment, is depicted. The pneumatic clamp mechanism 200 comprises a lateral actuator 210, a sliding table 220, a vertical actuator 330, a frame 240, a tabletop 250, a compression pad 260, and a pressure regulator 370. The vertical actuator 330 may comprise a vertical piston 332. Pressure regulator 370 may power the lateral actuator 210 and the vertical actuator 330. The pneumatic pistons may be powered by building air pressure and may be turned into active state through at least two solenoid valves 380. In an example embodiment, the pressure regulator 370 maintains a uniform pressure between 1 psi and 5 psi. The solenoids 380 may be turned off and on through their connection to a power supply. In an example embodiment, the power supply is a DC power supply, preferably a 24V DC power supply.

In an example embodiment, the impregnated textile enters the pneumatic clamp mechanism (150, 200, 300) that serves as a grab-pull-release stage. The pneumatic clamp mechanism (150, 200, 300) may comprise a pulling mechanism that is pneumatically driven and computer controlled. With brief reference to FIG. 1, in conjunction with the pneumatic clamp mechanism (150, 200, 300), an in-situ pneumatic press 160 at the end of the production line shapes the sample, ensures uniformity of the shape, and improves impregnation. Curing is done in a wet chamber under a suitable controlled environment, for example 23° C., 90% RH.

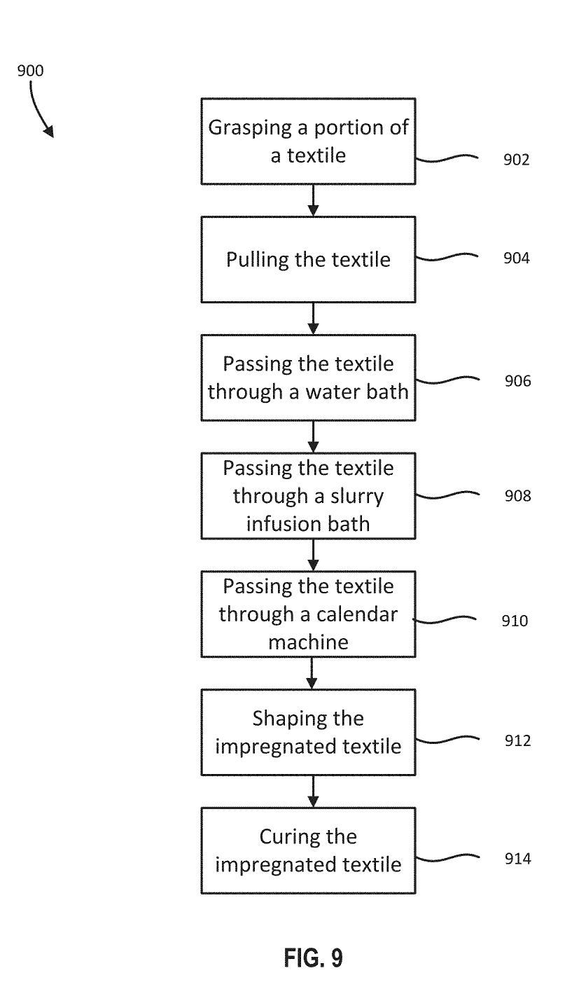

With reference now to FIG. 9, a method 900 for forming a three-dimensional textile reinforced concrete product, in accordance with an example embodiment, is depicted. First, a pneumatic clamp may grasp a portion of a textile (step 902). The pneumatic clamp may be a pneumatic clamp of FIG. 1, FIG. 2, and/or FIG. 3. The pneumatic clamp may grasp the textile by clamping the textile between a sliding table and a plate operatively connected to a vertical actuator. The pneumatic clamp may then pull the textile (step 904). The pneumatic clamp may pull the textile by a lateral actuator that is coupled to the sliding table. The lateral actuator may slide the grasped portion of the textile in a later direction and unwind the textile from a feeding station.

As the textile is unwound it may pass through a water bath (step 906). The water bath may comprise chemical additives. After passing through the water bath, the textile may pass through a slurry infusion bath (step 908), The slurry infusion bath may comprise a cement matrix. The slurry infusion bath may further comprise chemical admixtures. Upon exiting the slurry infusion bath, the textile may form an impregnated textile. The impregnated textile may then pass through a calendar machine (step 910). The calendar machine may comprise rollers disposed opposite of each other and configured to roll in opposite directions. The rollers may squeeze the impregnated textile and uniformly distribute at least a portion of the cement-based matrix across the textile. In various embodiments, the rollers may uniformly distribute the entire cement based matrix across the textile.

The impregnated textile may then be shaped by a pneumatic press (step 912). The pneumatic press may improve the impregnation of the cement matrix inside the openings of the impregnated textile and give the impregnated textile its desired shape. The desired shape be one of the following: angle sections, L sections, C sections, channels, hat sections, I sections, H sections, W sections, closed sections and sandwich sections. Then, the impregnated textile may be demolded and cured in a curing chamber under a controlled environment (step 914), In an example embodiment, the impregnated textile may be cured between 20 and 40 days, preferably about 28 days. In an example embodiment, multiple impregnated textiles may be cured at a single time. After the curing process, a TRC laminate in accordance with various embodiments may be formed.

Exemplary TRC systems as disclosed herein provide various benefits, including lighter weight products, on-site manufacturing, and so forth. As compared to prior approaches utilizing manual manufacturing, instead of manual construction procedures, exemplary systems and methods can be used in a factory setting or used on a flat-bed truck on site to manufacture desired composite materials. Exemplary systems and methods can be used in a factory setting to manufacture exemplary products, for example the structural elements for panels, trusses, and structural shapes out of cement based materials. Sandwich components may also be obtained by laminating the TRC on a lightweight core such as aerated concrete, structural EPS foam, and/or the like.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure, Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A pultrusion system for manufacturing three-dimensional textile reinforced concrete products, the system comprising:
a feeding station having a textile wound thereon;
a slurry infusion bath having rollers disposed therein;
a calendar machine comprising a first roller and a second roller, the first roller disposed opposite the second roller, and the first roller configured to rotate in an opposite direction of the second roller; and
a pneumatic clamp configured to grab, pull, and release the textile to convey the textile through the pultrusion system.

2. The system of claim 1, wherein the pneumatic clamp is computer controlled.

3. The system of claim 2, further comprising a pneumatic press to shape the textile reinforced concrete.

4. The system of claim 3, further comprising a wet chamber for curing the textile reinforced concrete.

5. The system of claim 1, wherein the pneumatic clamp comprises a lateral actuator and a vertical actuator, the vertical actuator being configured to grab and release the textile, and the lateral actuator being configured to pull the textile.

6. The system of claim 5, wherein the pneumatic clamp further comprises a sliding table and a plate, the sliding table coupled to the lateral actuator, the plate being coupled to the vertical actuator, wherein the sliding table and the plate are configured to receive the textile therebetween.

7. The system of claim 1, wherein the slurry infusion bath comprises a cement based matrix.

8. The system of claim 7, wherein the slurry infusion bath further comprises a chemical admixture.

9. A method for forming a three-dimensional textile reinforced concrete product, the method comprising:
grasping, via a pneumatic clamp, a portion of a textile;
pulling, via the pneumatic clamp, the textile to cause the textile to unroll from a feeding station, pass through a water bath, pass through a slurry infusion bath, and form an impregnated textile; and
passing the impregnated textile through a calendar machine comprising rollers.

10. The method of claim 9, further comprising shaping the impregnated textile via a pneumatic press.

11. The method of claim 10, further comprising curing the impregnated textile in a wet chamber to form the three-dimensional textile reinforced concrete product.

12. The method of claim 9, wherein grasping the portion of the textile further comprises clamping, via the pneumatic clamp, the textile between a plate and a sliding table.

13. The method of claim 12, wherein pulling the textile further comprises sliding the sliding table, via a lateral actuator of the pneumatic clamp.

14. The method of claim 9, wherein the impregnated textile comprises a cement based matrix from the slurry infusion bath.

15. The method of claim 14, wherein passing the impregnated textile further comprises squeezing the impregnated textile and uniformly distributing the cement based matrix across the textile.
